(19) United States
(12) Patent Application Publication
(10) Pub. No.: US 2011/0081093 A1
(43) Pub. Date: Apr. 7, 2011

(54) IMAGE CODING METHOD WITH TEXTURE SYNTHESIS

(76) Inventors: Fabien Racape, Rennes (FR); DominQue Thoreau, Sevigne (FR); Jérôme Vieron, Rennes (FR); Aurélie Martin, Rennes (FR); Gabrielle Ombrouck, Rennes (FR)

(21) Appl. No.: 12/737,034

(22) PCT Filed: Jun. 4, 2009
(86) PCT No.: PCT/EP2009/056903

§ 371 Date: Dec. 2, 2010

(30) Foreign Application Priority Data
Jun. 5, 2008 (FR) 0853721

(51) Int. Cl. G06K 9/36

(52) U.S. Cl. 382/233

(57) ABSTRACT

Method for coding using a technique for synthesis of images and image regions exploiting a synthesis algorithm that operates on a set of patches, this operation carried out through the intermediary of a low resolution image, comprising the following steps:
decision making for coding or non-coding of regions of the synthesized image by comparison of the display with the source image, according to a quality metric,
for the regions synthesized with a coding decision, conventional coding of patches as well as of the low resolution image,
for the regions synthesized with a non-coding decision, coding according to a conventional coding schema.

The invention is situated in the context of image synthesis and more specifically in the domain of video compression. The synthesis method applies to the coder and to the decoder.

The method consists in synthesizing the content of an image from texture patches, the patches in question being:
image blocks of reduced dimensions,
representative blocks, from the point of view of texture, of different regions composing the image.

Moreover on the basis of a quality metric, the display of the synthesis thus obtained is compared to the source on the coder side, the parts of the reconstructed image not responding to a level of quality judged as being acceptable by the criterion are then encoded by a more conventional technique, such as for example:
the metric could be SSIM,
standard coding H264-AVC.

### Synthesis Algorithm

With respect to the known synthesis methods, pixel based techniques can be cited, in the sense that the pixels are constructed one by one, one of the algorithms can be cited developed by L.-Y. Wei and M. Levoy “Fast texture synthesis using tree-structured vector Quantization”. Proceedings of SIG-GRAPH 2000 (July 2000), 479-488. [1]

The purpose here is to synthesize a large texture area from a “patch” that is smaller but that contains all the information required concerning patterns. The quality of the algorithm resides in the fact that this synthesized image does not have to display visible borders or periodicities.

FIG. 1 describes the principle of the algorithm. It has two inputs, a texture patch and an image of the desired dimensions, initialised by a noise in order to avoid the periodicities. It returns at output an image synthesized from the texture.

### Characteristics of the Search for the Best Pixel

The comparison of neighbouring areas is done “pixel by pixel” via the standard L2. Thus the error minimized here has the form:

$$ɛ = {\sum }_{pixels} {\sum }_{RGB} {( {x}_{synth} - {x}_{patch} )}^{2}$$

With x_{synth} and x_{patch} the values of each RGB colour of the pixel considered of the current image and of the patch. Each pixel of the neighbouring area of the current pixel is thus compared with its opposite of the neighbouring area of the pixel tested in the patch.

The neighbouring area is constituted of pixels surrounding the current pixel, it is comprised in a square of given dimensions [dxd]. It is called “causal” when it only comprises pixels already synthesized in the current image. Here it is thus causal neighbouring areas that are used as the non-causal part of the neighbouring area in the current area only comprises noise pixels and is of no interest for the comparison.

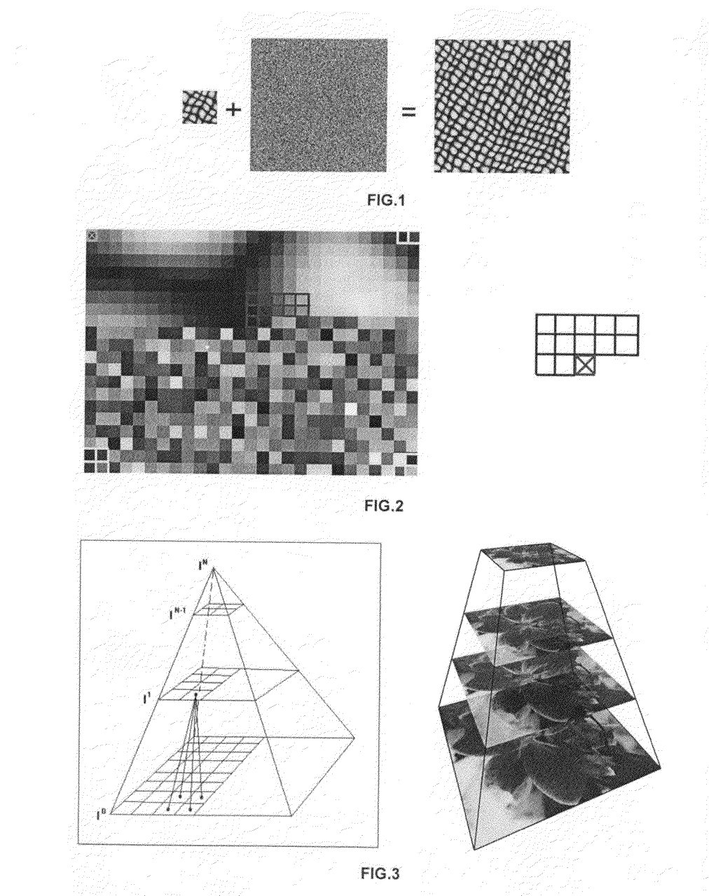

FIG. 2 shows such causal neighbouring areas. For the first pixels, first lines and first and last columns, the output image is periodized thus the pixels taken into account are on the other side of the image as shown for the first pixel in the corner (x) and its neighbouring areas situated in the four corners of the image.

### Multi-Resolution Approach

The main problem raised by the exhaustive approach remains the calculation time required to synthesize images of reasonable size. This calculation time being correlated with the size of the neighbouring area, this multi-resolution approach will enable the performances to be improved. The main idea introduced in [1] is to use images of lower resolutions so that 5×5 or 3×3 neighbouring areas extend over the texture like 15×15 neighbouring areas in simple resolution. To do this, you begin by creating pyramids, one for the patch and one for the image synthesized using a sub-sampler filter, as shown in FIG. 3.

The algorithm then synthesizes the current image pyramid, from the lowest resolution to the highest resolution, as follows
The image of lowest resolution is synthesized in the same way as in the case of the simple resolution technique.
The other images are synthesized in the same way, with the exception that the neighbouring areas do not only contain pixels of the current resolution, but also pixels of the neighbouring area of the pixel corresponding to the current at the lower resolution.
The last image is thus the output image synthesized from the patch and images of lower resolution.

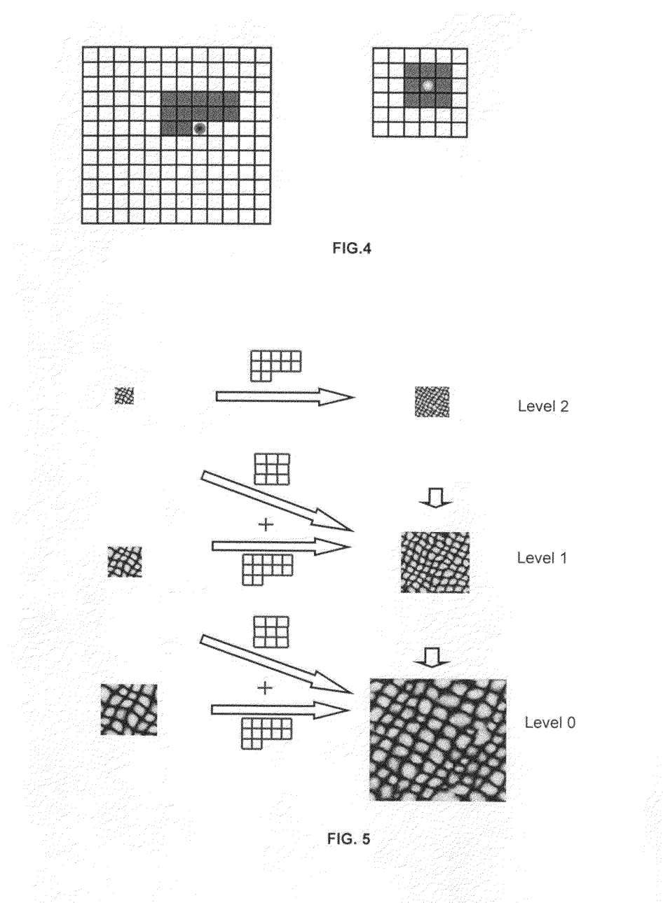

FIG. 4 shows a multi-resolution neighbouring area. This neighbouring area contains pixels of the causal neighbouring area of the level n current resolution, shown in dark gray in the left schema, pixels contained in the non-causal neighbouring area of resolution higher than level n+1, pixels represented in dark gray and the parent in the centre shown in lighter gray, in the schema on the right. In this example, the neighbouring area contains 12+9=21 pixels.

FIG. 5 shows the order of the multi-resolution synthesis. The upper image, level 2, corresponds to the synthesis of the first level, causal neighbouring area. The lower images, level 1 and level 0, correspond to the synthesis of the second level, causal neighbouring area.

### Quality Metric: SSIM

The purpose of the invention being to synthesize an image via texture patches with the objective of image compression, it is obviously necessary the estimate the recovery quality of synthesized image parts in comparison with the source image (on the coder side). These synthesis base reconstruction techniques have a tendency to implicitly give rise to a reconstructed signal that moves away from the original signal in terms of standard distortion of sse (sum of squared error) type, but however offer a visual display that may be entirely acceptable, it is here that the quality metric is confronted. Currently there is a lot of work on the subject, however this paper will be directed towards a measure of a more psycho-visual character called Structural Similarity (SSIM) described for example in the document by Z. Wang, L. Lu, A. C Bovik, “Video quality assessment based on structural distortion measure” Signal processing image communication vol 19 n^{o} 2, pp 121-132, February 2004.

This measure is composed of three terms are enables the disparities to be estimated. The SSIM formulation is the following:

$$S S I M ( s , r ) = \frac{( 2 {μ}_{s} {μ}_{c} + {C}_{1} ) ( 2 {σ}_{sc} + {C}_{2} )}{( {μ}_{s}^{2} + {μ}_{c}^{2} + {C}_{1} ) ( {σ}_{s}^{2} + {σ}_{c}^{2} + {C}_{2} )} \qquad ( 5 )$$

where:
μₛ: average of the luminance of source pixels,
σₛ: variance of source pixels,
μ_{c}: average of the luminance of synthesized pixels,
σ_{c}: variance of reconstructed pixels,
σ_{sc}: covariance of source and synthesized pixels,
c₁=(k_{I}L)², c₂=(k₂L)²: two variables intended to stabilize the division when the denominator is very low,
L is the dynamic of pixel values, thus here 256 for the colours coded on 8 bits,
k₁=0.01 and k₂=0.03 by default.

SSIM is applied per 8×8 block in the image, relative to each pixel of the image.

One of the purposes of the invention is to overcome the aforementioned disadvantages. The purpose is a method for image decoding using a technique for synthesis of images and image regions exploiting a synthesis algorithm that operates on a set of patches, this operation is carried out through the intermediary of a low resolution image, characterized in that it comprises the following steps for:
decoding of patches as well as the low resolution image, the patches can come from images previously decoded or can be decoded independently of the images themselves,
reconstruction of regions according to a synthesis algorithm using these patches and this low resolution image as supports,
decoding in a conventional way, for the regions not coded by synthesis, the regions thus decoded substituting for those already possibly reconstructed in the synthesized image.

According to a particular embodiment, the synthesis technique is of pyramidal type.

According to a particular embodiment, the low resolution image has a spatial scalability type form so that the synthesis algorithm is punctually guided to pyramid levels other than the lowest resolution level.

According to a particular embodiment, the synthesis algorithm operates on an image signal RVB, an image signal YUV or a luminance signal Y alone, the signals U and V undergoing the same processing as the processing applied to the luminance.

The purpose is also a method for image compression using a technique for synthesis of images and image regions exploiting a synthesis algorithm that operates on a set of patches, this operation being performed by the intermediary of a low resolution image, characterized in that it comprises the following steps:
decision making for coding or non-coding of regions of the synthesized image by comparison of the display with the source image, according to a quality metric,
for the regions synthesized with a coding decision, conventional coding of patches as well as of the low resolution image,
for the regions synthesized with a non-coding decision, coding of these regions according to a conventional coding schema.

According to a particular embodiment, the synthesis technique is of pyramidal type.

According to a particular embodiment, the low resolution image has a spatial scalability type form so that the synthesis algorithm is punctually guided to pyramid levels other than the lowest resolution level.

According to a particular embodiment, the synthesis algorithm operates on an image signal RVB, an image signal YUV or a luminance signal Y alone, the signals U and V undergoing the same processing as the processing applied to the luminance.

According to a particular embodiment, the quality metric is SSIM (Structural SIMilarity).

The invention enables the synthesis of images and image regions to be improved by using a synthesis algorithm that operates on a set of patches, this operation being carried out by the intermediary of a low resolution image. The application targeted being video compression, a quality metric intervenes in order to code typically the areas of the image badly reconstructed or to or to leave as they are the areas in question.

A first advantage of the invention is thus to enable an acceptable visual display (based on the quality metric) of image regions reconstructed via a synthesis algorithm, this synthesis being guided at the coder and decoder by an image transmitted of low resolution, in order finally to reduce the bit rate at a given visual quality, and vice versa.

It should be noted that this technique does not require a segmentation card to be transmitted to the decoder, the synthesis algorithm naturally operating the distribution of the information contained in the different patches through the intermediary of the guiding image. In addition, the display imperfections by the synthesis technique are corrected by a standard coding, said areas of imperfection being detected by a quality metric, this metric can be the SSIM. A second advantage of the invention is the scalability of the representation, which enables the signal to be decoded at a chosen resolution.

Another advantage is the possibility to code the low resolution image according to an existing coding technique, for example H.264, thus assuring a backward compatibility with these coding techniques.

### Guided Synthesis

The idea is to transmit to the hierarchical synthesis algorithm the sub-sampled version of the reference image that will serve as guide for the synthesis of the lowest resolution of the pyramid. The synthesis of this low resolution image is made with a non-causal neighbouring area. For example the exhaustive approach of L. Y. Wei and M. Levoy is chosen that consists in comparing this neighbouring area with all of those of the patch in order to determine the best candidate.

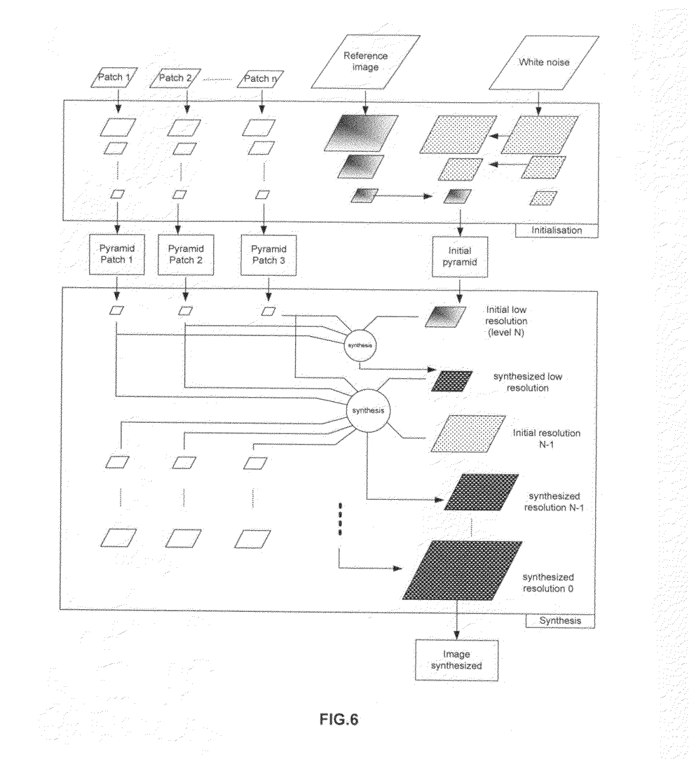

The different steps of the method, shown by FIG. 6 that shows a block diagram of guided synthesis, are then the following:
1) The algorithm sub-samples the reference image as many times as there are levels in the Gaussian pyramid used in the multi-resolution algorithm.
2) This low resolution image is then copied as initialization of the synthesized image, replacing the white noise of initialization proposed in the approach of L. Y. Wei and M. Levoy.
3) Several patches corresponding to the different textured parts of the image are supplied to the algorithm.
4) The low resolution image is then synthesized with a (non-causal) squared neighbouring area. The non-causal part of the neighbouring area calculated on the image in construction relies then on the sub-sample reference image. The exhaustive algorithm tests then all the neighbouring areas of all the patches supplied. The non-causal part of the current neighbouring area will then guide the synthesis to the patch that has the characteristics closest to the part of the sub-sampled image.
5) The algorithm retains in memory from which patch each synthesized pixel comes from.
6) For the upper levels, the synthesis technique remains unchanged, searching only in the patch memorized at the preceding resolution, this is in order to accelerate the synthesis, nevertheless in one of the variants of the method, the synthesis algorithm can punctually be guided/contained at pyramid levels other than the level of lowest resolution.

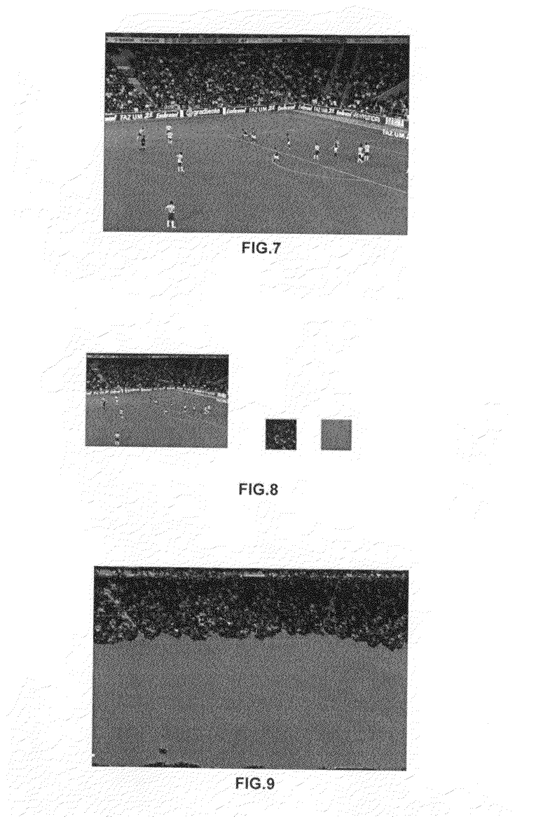

Take for example, to illustrate this type of synthesis, an image from a football match. This reference image is shown in FIG. 7. It is noted that this image has two areas where synthesis could be a good way to retain the high frequencies typically sacrificed in standard coding algorithms: the pitch and the public. It is thus decided to transmit to the algorithm 3 input images, shown in FIG. 8, the version sub-sampled twice, one sample of the public and one sample of the pitch.

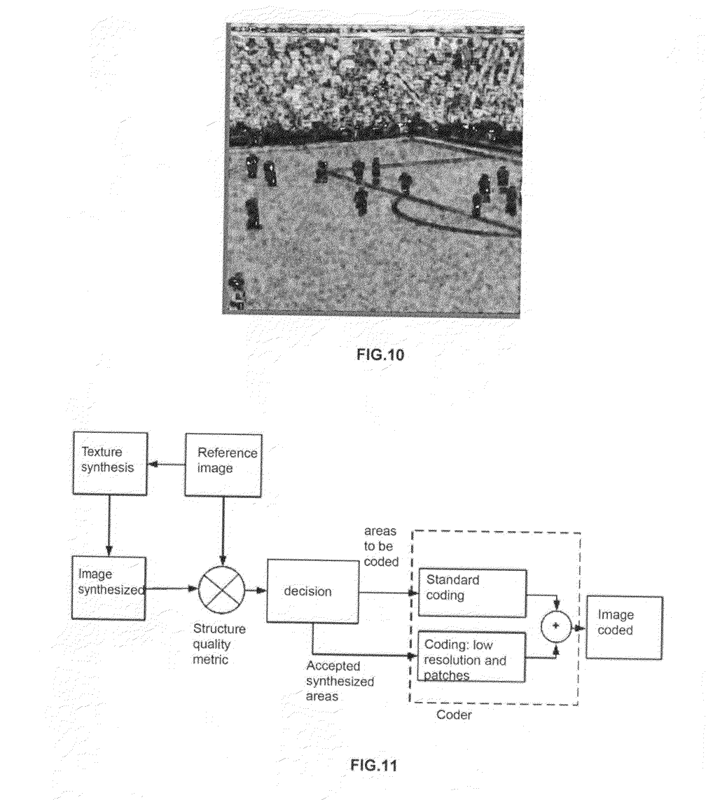

The synthesized image of dimensions 768×512, shown in FIG. 9, is obtained by this algorithm with the following characteristics:
Neighbouring areas of the current resolution: 5×5 pixels
Neighbouring areas of resolution n+1: 3×3 pixels
Number of pyramid levels: 3

### Associated Metric

In order to measure if the texture synthesis is revealed as pertinent on the regions of the image produced, a quality metric is used capable of revealing the display of the structure.

In taking again the previous example and a possible metric, the SSIM, a mapping is obtained of the SSIM as shown in FIG. 10.

Several decision modes can be applied:
use of a threshold, applied on the metric enabling the elements of the image to be encoded or non-encoded to be distinguished,
placing into competition of the measurement obtained and that obtained with the “standard” coding modes.

FIG. 11 shows the general block diagram of the coding method.

The applications concerned are those linked to video compression. More specifically, the very low and low bitrate applications (for example HD for mobile) as well as super resolution (HD and +).

1. Method for image decoding using a technique for synthesis of images and image regions exploiting a synthesis algorithm that operates on a set of patches, this operation being performed by the intermediary of a low resolution image, comprising the following steps:
decoding of patches as well as the low resolution image, the patches can come from images previously decoded or can be decoded independently of the images themselves,
reconstruction of regions according to a synthesis algorithm using these patches and this low resolution image as supports,
decoding in a conventional way, for the regions not coded by synthesis, the regions thus decoded substituting for those already possibly reconstructed in the synthesized image.

2. Method according to claim 1, wherein the synthesis technique is of pyramidal type.

3. Method according to claim 2, wherein the low resolution image has a spatial scalability type form so that the synthesis algorithm is punctually guided to pyramid levels other than the lowest resolution level.

4. Method according to claim 1, wherein the synthesis algorithm operates on an image signal RVB, an image signal YUV or a luminance signal Y alone, the signals U and V undergoing the same processing as the processing applied to the luminance.

5. Method for image compression using a technique for synthesis of images and image regions exploiting a synthesis algorithm that operates on a set of patches, this operation being performed by the intermediary of a low resolution image, comprising the following steps:
decision making for coding or non-coding of regions of the synthesized image by comparison of the display with the source image, according to a quality metric,
for the regions synthesized with a coding decision, conventional coding of patches as well as of the low resolution image,
for the regions synthesized with a non-coding decision, coding of these regions according to a conventional coding schema.

6. Method according to claim 5, wherein the synthesis technique is of pyramidal type.

7. Method according to claim 6, wherein the low resolution image has a spatial scalability type form so that the synthesis algorithm is punctually guided to pyramid levels other than the lowest resolution level.

8. Method according to claim 5, wherein the synthesis algorithm operates on an image signal RVB, an image signal YUV or a luminance signal Y alone, the signals U and V undergoing the same processing as the processing applied to the luminance.

9. Method according to claim 5, wherein the quality metric is the SSIM (Structural SIMilarity) quality metric.
